(19) United States
(12) Patent Application Publication
(10) Pub. No.: US 2015/0116650 A1
(43) Pub. Date: Apr. 30, 2015

(54) SMART POLARIZING GLASSES

(71) Applicants: FIH (Hong Kong) Limited, Kowloon (HK); SHENZHEN FUTAIHONG PRECISION INDUSTRY CO., LTD., Shenzhen (CN)

(72) Inventor: JIAN-HUI LI, Shenzhen (CN)

(73) Assignees: FIH (Hong Kong) Limited, Kowloon (HK); SHENZHEN FUTAIHONG PRECISION INDUSTRY CO., LTD., Shenzhen (CN)

(21) Appl. No.: 14/104,063

(22) Filed: Dec. 12, 2013

(30) Foreign Application Priority Data
Oct. 31, 2013 (CN) 201310526690X

(51) Int. Cl. G02C 7/12; G02B 27/28; G02C 7/08

(52) U.S. Cl. CPC G02C 7/12; G02C 7/086; G02B 27/286
USPC 351/47

(57) ABSTRACT

A smart polarizing glasses includes two legs, a fixed lens, a movable lens, and a control assembly. The fixed lens is fixed between the two legs. The movable lens is rotatably mounted between the two legs. The control assembly is detachably mounted on one leg. According to ambient light intensity, the control assembly automatically drives the movable lens to rotate to cover the fixed lens or have no overlap with the fixed lens.

### BACKGROUND

1. Technical Field

The present disclosure relates to smart polarizing glasses, and more particularly to a smart polarizing glasses which can adjust a position of polarizing lens according to ambient light.

2. Description of Related Art

Bright ambient light will harm people's eyes, and it is dangerous especially when driving. Generally, people wear polarizing glasses to protect eyes. According to ever-changing ambient light, people don't need to wear polarizing glasses at all times. For example, the polarizing glasses should be taken off under dim light conditions. However, it is inconvenient and dangerous to take off the polarizing glasses while driving.

Therefore, there is room for improvement within the art.

### BRIEF DESCRIPTION OF THE DRAWINGS

Many aspects of the present smart polarizing glasses can be better understood with reference to the following drawings. The components in the various drawings are not necessarily drawn to scale, the emphasis instead being placed upon clearly illustrating the principles of the present smart polarizing glasses.

FIG. 1 is a schematic view of a smart polarizing glasses, according to an exemplary embodiment.

FIG. 2 is an exploded view of the smart polarizing glasses shown in FIG. 1.

FIG. 3 is a block diagram of a control system of the smart polarizing glasses shown in FIG. 1.

### DETAILED DESCRIPTION

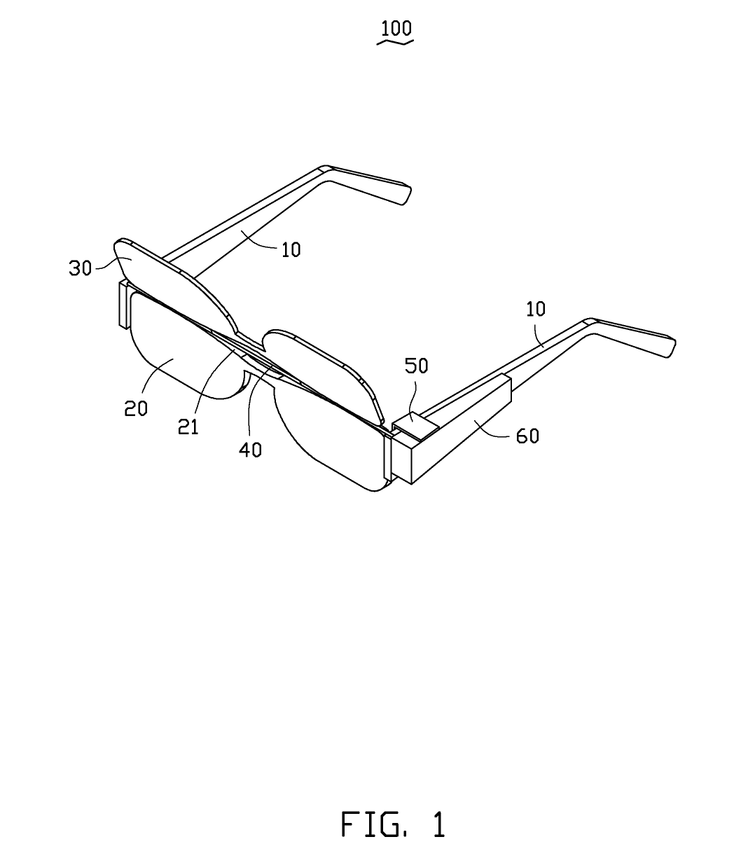

FIG. 1 shows a smart polarizing glasses 100. The smart polarizing glasses 100 includes two legs 10, a fixed lens 20, a movable lens 30, a connecting element 40, a fixing element 50 and a control assembly 60. The fixed lens 20 is fixed between the two legs 10. The connecting element 40 is connected between the two legs 10 and is located above the fixed lens 20. The movable lens 30 is connected to the connecting element 40. The control assembly 60 is attached to one leg 10 by the fixing element 50. The connecting element 40 rotates under the control of the control assembly 60 and drives the movable lens 30 to rotate to toward or away from the fixed lens 20.

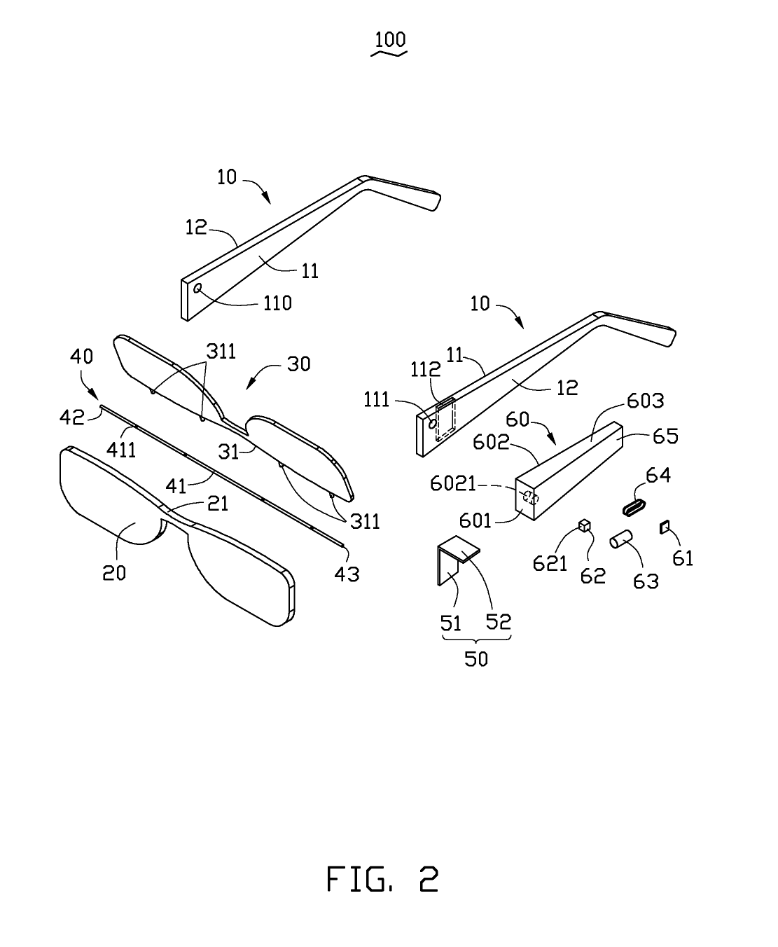

FIG. 2 is an exploded view of the smart polarizing glasses 100. Each leg 10 includes an inner wall 11 and an outer wall 12. One inner wall 11 defines a coupling hole 110, and the other inner wall 11 defines a through hole 111 and a latching groove 112. The coupling hole 110 is aligned with the through hole 111. The fixed lens 20 is fixed between the inner walls 11 by adhesive or screws (not shown). In this embodiment, the fixed lens 20 is glass lens, and the movable lens 30 is polarized lens. The fixed lens 20 includes a top surface 21.

The connecting element 40 is substantially rod-shaped and includes a peripheral surface 41, a first end 42 and a second end 43. The first end 42 is rotatably received in the coupling hole 110, and the second end 43 passes through the through hole 111 and is exposed to the leg 10. The peripheral surface 41 defines a plurality of notches 411. The connecting element 40 is located above the top surface 21 of the fixed lens 20. The movable lens 30 has the same shape as the fixed lens 20 and includes a fixing surface 31. A plurality of protrusions 311 corresponding to the plurality of notches 411 are evenly spaced apart from each other and are located on the fixing surface 31.

The fixing element 50 is substantially a L-shaped plate and includes a first connecting portion 51 and a second connecting portion 52. The first connecting portion 51 is perpendicularly connected to the second connecting portion 52. The first connecting portion 51 is engaged with the latching groove 112, and the second connecting portion 52 is attached to the control assembly 60.

The control assembly 60 includes a processor 61, a light sensor 62, a motor 63, a drive belt 64, and a receiving element 65. The receiving element 65 is substantially a hollow trapezoidal prismoid and receives the processor 61, the light sensor 62, the motor 63, and the drive belt 64. The receiving element 65 includes an end surface 601, a first surface 602, and a second surface 603 adjacent to the first surface 602. The first surface 602 and the second surface 603 are connected to the end surface 601. The light sensor 62 includes a light-sensitive surface 621 located on the end surface 601, the light-sensitive surface 621 is exposed to the external environment. The first surface 602 defines a receiving slot 6021 for receiving the second end 43. The second connecting portion 52 is attached to the second surface 603.

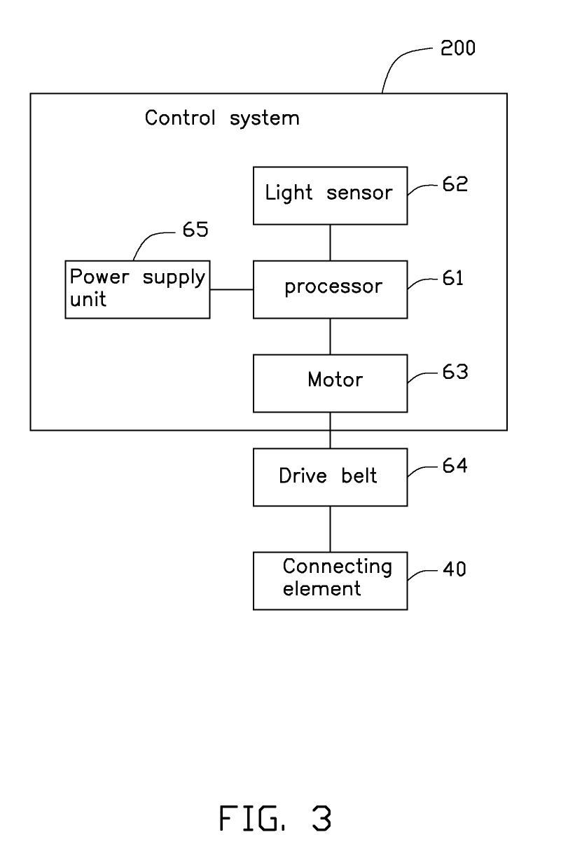

FIG. 3 is a block diagram of a control system 200 of the smart polarizing glasses 100. The control assembly 60 further includes a power supply unit 65. The power supply unit 65 can be a battery or be powered by an external power device. The processor 61, the light sensor 62, the motor 63, and the power supply unit 65 constitute the control system 200. The light sensor 62, the motor 63, and the power supply unit 65 are electronically connected to the processor 61. The motor 63 is connected to the connecting element 40 by the drive belt 64.

In assembly of the smart polarizing glasses 100, the fixed lens 20 is fixed between the two inner walls 11. The first end 42 is rotatably received in the coupling hole 110, and the second end 43 passes through the coupling hole 110 to be received in the receiving slot 6021. The second end 43 is connected to the drive belt 64. Each protrusion 311 is engaged with one of the plurality of notches 411. The first surface 602 of the receiving element 65 fits tightly with the outer wall 12 of the leg 10 which defines the latching groove 112. The first connecting portion 51 is received in the latching groove 112, and the second connecting portion 52 is attached to the control assembly 60.

The user wears the smart polarizing glasses 100, the light sensor 62 senses the ambient light intensity, and sends a sensing signal to the processor 61. The processor 61 stores a comparison value, and compares a light intensity value of the ambient light with the comparison value. If the light intensity value of the sensing signal is greater than or equal to the comparison value, the processor 61 causes the motor 63 to rotate in a clockwise direction or a counterclockwise direction, and the motor 63 drives the connecting element 40 to rotate by the drive belt 64. The connecting element 40 drives the movable lens 30 to rotate until the movable lens 30 covers the fixed lens 20. If the light intensity value of the sensing signal is less than the comparison value, the processor 61 causes the motor 63 to rotate in a counterclockwise direction or a clockwise direction, and the motor 63 drives the connecting element 40 to rotate by the drive belt 64. The connecting element 40 drives the movable lens 30 to rotate away from the fixed lens 20 until the movable lens 30 and the fixed lens 20 have no overlap.

According to the ambient light intensity, the control assembly 60 causes the connecting element 40 to rotate to adjust the locations of the movable lens 30. The control assembly 60 is detachably mounted on the leg 10 with the fixing element 50, allowing easy assembly.

In another exemplary embodiment, the drive belt 64 is omitted, and the motor 63 directly drives the connecting element 40.

In another exemplary embodiment, the fixed lens 20 is myopic lens.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A smart polarizing glasses, comprising:
two legs;
a fixed lens fixed between the two legs;
a movable lens rotatably mounted between the two legs; and
a control assembly detachably mounted on one leg;
wherein according to ambient light intensity, the control assembly automatically drives the movable lens to rotate to cover the fixed lens or have no overlap with the fixed lens.

2. The smart polarizing glasses as claimed in claim 1, wherein the control assembly stores a comparison value and senses ambient light intensity, the control assembly compares a light intensity value of the ambient light with the comparison value, if the light intensity value is greater than or equal to the comparison value, the control assembly drives the movable lens to rotate to cover the fixed lens; if the light intensity value is less than the comparison value, the control assembly drives the movable lens to rotate away from the fixed lens until the movable lens and the fixed lens have no overlap.

3. The smart polarizing glasses as claimed in claim 2, further comprises a connecting element rotatably mounted between the two legs, the movable lens is fixed on the connecting element.

4. The smart polarizing glasses as claimed in claim 3, wherein the connecting element comprises a peripheral surface defining a plurality of notches; the movable lens comprises a fixing surface, a plurality of protrusions are located on the fixing surface; each protrusion is engaged with one of the plurality of notches.

5. The smart polarizing glasses as claimed in claim 3, wherein an inner wall of one leg defines a coupling hole, and an inner wall of the other leg defines a through hole; the connecting element comprises a first end and a second end, the first end is rotatably received in the coupling hole, and the second end passes through the through hole and is exposed to the leg.

6. The smart polarizing glasses as claimed in claim 5, wherein the control assembly comprises a first surface defining a receiving slot, the second end is received in the receiving slot.

7. The smart polarizing glasses as claimed in claim 6, further comprises a fixing element; the inner wall of the other leg defines a latching groove adjacent to the through hole; the fixing element comprises a first connecting portion and a second connecting portion connected to the first connecting portion; the first connecting portion is engaged with the latching groove, and the second connecting portion is attached to the control assembly.

8. The smart polarizing glasses as claimed in claim 3, wherein the control assembly comprises a processor, a light sensor and a motor; the light sensor and the motor are electronically connected to the processor, the connecting element is rotatably connected to the motor.

9. The smart polarizing glasses as claimed in claim 8, wherein the control assembly further comprises a power supply unit electronically connected to the processor.

10. The smart polarizing glasses as claimed in claim 8, wherein the control assembly further comprises a receiving element comprising an end surface, the light sensor comprises a light-sensitive surface located on the end surface, the light-sensitive surface is exposed to an external environment.

11. A smart polarizing glasses, comprising:
two legs;
a fixed lens fixed between the two legs;
a movable lens rotatably mounted between the two legs; and
a control assembly detachably mounted on one leg;
wherein the control assembly stores a comparison value and senses ambient light intensity, according to a comparison result between the comparison value and a light intensity value of the ambient light, the control assembly automatically drives the movable lens to rotate to cover the fixed lens or have no overlap with the fixed lens.

12. The smart polarizing glasses as claimed in claim 11, wherein if the light intensity value is greater than or equal to the comparison value, the control assembly drives the movable lens to rotate to cover the fixed lens; if the light intensity value is less than the comparison value, the control assembly drives the movable lens to rotate away from the fixed lens until the movable lens and the fixed lens have no overlap.

13. The smart polarizing glasses as claimed in claim 12, further comprises a connecting element rotatably mounted between the two legs, the movable lens is fixed on the connecting element.

14. The smart polarizing glasses as claimed in claim 13, wherein the connecting element comprises a peripheral surface defining a plurality of notches; the movable lens comprises a fixing surface, a plurality of protrusions are located on the fixing surface; each protrusion is engaged with one of the plurality of notches.

15. The smart polarizing glasses as claimed in claim 13, wherein an inner wall of one leg defines a coupling hole, and an inner wall of the other leg defines a through hole; the connecting element comprises a first end and a second end, the first end is rotatably received in the coupling hole, and the second end passes through the through hole and is exposed to the leg.

16. The smart polarizing glasses as claimed in claim 15, wherein the control assembly comprises a first surface defining a receiving slot, the second end is received in the receiving slot.

17. The smart polarizing glasses as claimed in claim 16, further comprises a fixing element; the inner wall of the other leg defines a latching groove adjacent to the through hole; the fixing element comprises a first connecting portion and a second connecting portion connected to the first connecting portion; the first connecting portion is engaged with the latching groove, and the second connecting portion is attached to the control assembly.

18. The smart polarizing glasses as claimed in claim 13, wherein the control assembly comprises a processor, a light sensor and a motor; the light sensor and the motor are electronically connected to the processor, the connecting element is rotatably connected to the motor.

19. The smart polarizing glasses as claimed in claim 18, wherein the control assembly further comprises a power supply unit electronically connected to the processor.

20. The smart polarizing glasses as claimed in claim 18, wherein the control assembly further comprises a receiving element comprising an end surface, the light sensor comprises a light-sensitive surface located on the end surface, the light-sensitive surface is exposed to an external environment.
